(19) United States
(12) Patent Application Publication
(10) Pub. No.: US 2005/0021953 A1
(43) Pub. Date: Jan. 27, 2005

(54) Method for transferring mobile programs

(75) Inventor: Peter Trommler, Munchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/795,581

(22) Filed: Mar. 9, 2004

(30) Foreign Application Priority Data
Mar. 10, 2003 (DE) 103 103 72.4

(51) Int. Cl. H04L 9/00

(52) U.S. Cl. 713/166

(57) ABSTRACT

The invention relates to a method for transferring mobile programs from a first computer onto a second computer, on which the mobile program can be executed. The mobile program is loaded onto the second computer from the first computer, and one or more policies are loaded onto the second computer. The policies stipulate a set of access rights for the mobile program regarding data which are to be processed by the mobile program, and the policies comprise one or more declarations which can be displayed to the user of the mobile program. The declarations include information relating to execution of the mobile program with the access rights stipulated by the policies.

### CLAIM FOR PRIORITY

This application claims the benefit of priority to German Application No. 10310372.4, filed in the German language on Mar. 10, 2003, the contents of which are hereby incorporated by reference.

### TECHNICAL FIELD OF THE INVENTION

The invention relates to a method for transferring mobile programs and to a corresponding arrangement for transferring mobile programs.

### BACKGROUND OF THE INVENTION

Mobile programs, particularly mobile code, such as JAVA applets, are frequently used in data communication systems today. Such mobile programs have proved themselves particularly for Internet applications, since a user can download the mobile program from a central server and can execute it on his own computer. The user thus has not only his locally used applications available but also a multiplicity of programs which can be retrieved from the Internet. However, the use of mobile programs on a local computer entails drawbacks regarding security-related aspects, since the programs are sometimes not trustworthy and can thus manipulate data on the local computer unwelcomly.

The prior art has already disclosed various security mechanisms for the use of mobile programs, these security mechanisms attempting to prevent unwanted external attacks on local data. An outline of known security mechanisms can be found in the printed document Peter Trommler: “The Application Profile Model: A Security Model for Downloaded Executable Content”; thesis at the Faculty of Economics at the University of Zurich; December 1999.

The known security mechanisms can be divided into four groups. A first method for ensuring data integrity is the execution of mobile programs in a “sandbox” environment which permits no dangerous actions by the mobile program. Although this method is very secure, many useful functions of the program cannot be performed.

A second security mechanism involves the mobile program code not being executed until after a digital signature has been checked. The digital signature verifies that the program code comes from a location which the user can trust. Only if a program code has been signed by the trustworthy location in question is it able to be executed without restrictions. A drawback of this method is that the user has to trust the signer of the program code entirely but might actually wish to trust the signer as little as possible.

A further security mechanism likewise involves the program code being signed, but with the signature being coupled to data access rights which are defined for the signer. It is thus possible to stipulate various access rights for different signers, depending on trustworthiness. This is essentially equivalent to allocating user identifiers for the signers, but with the program user needing to define the scope of the access rights using a “policy”. In this context, there is the risk that the program user might define the policy too broadly through lack of knowledge and, in the extreme case, might even dispense with all security-related restrictions during program execution.

In a further method, the program code is likewise signed and is executed at the user end only with verification of the signature, execution of the program taking into account specific access rights which are dependent on the program application. Unlike in the previous method, the access rights are now coupled to the program application, with more broadly defined access rights being able to be granted for less security-critical program applications. In the case of this security mechanism, however, it is likewise necessary for policies to be defined by the user, which is very complex and is almost impossible for a user who is not familiar with the software programming.

The security mechanisms described above have the drawback that the program's access rights are not presented to the user in comprehensible form or that the access rights need to be stipulated by the user of the mobile program himself, whereas only a few users have sufficient programming experience to define the access rights in a “policy” according to their requirements.

### SUMMARY OF THE INVENTION

The invention to provides a method for transferring mobile programs, where, following transfer of the program, the user has information available regarding the security mechanisms which are used when the program is executed.

In one embodiment of the invention, there are mobile programs being transferred from a first computer to a second computer, with the mobile program being able to be executed on the second computer. In this context, the first computer may be an Internet server, in particular, from which a user downloads a mobile program onto his local PC, which in this case is the second computer. When a mobile program has been loaded onto the second computer from the first computer, one or more policies stipulating a set of access rights for the mobile program regarding data which are to be processed by the mobile program are loaded onto the second computer. The policies comprise not only machine-readable code stipulating the access rights but also one or more declarations which are intended for and can be displayed to the user of the mobile program, the declarations containing information relating to execution of the mobile program with the access rights stipulated by the policies. Preferably, these declarations are displayed to the user before the program is executed. This means that the user is transparently notified of the extent to which the program manipulates data on the second computer using a particular policy. In one particularly preferred embodiment, the declarations include information relating to security-critical program operations during execution of the program. In contrast to the prior art, in which the policies used cannot be viewed by the user and, moreover, are incomprehensible, the present invention involves the policies containing implemented declarations which are comprehensible to the user and which the user can use to decide whether he actually wishes to execute the program.

In another embodiment, the policies include declarations for different target user groups, which means that the user is able to view information which is relevant and comprehensible particularly to his target group (e.g. programmers, security experts, users).

In one preferred embodiment, the mobile program is connected to the policies in the following manner:

First, identification data for identifying the mobile program are transferred from the first computer to a third computer, the third computer having access to the policies. Next, at least one of the policies and the identification data are provided with a signature, the signature being used to declare that a mobile program which can be identified using the identification data is behaving in accordance with the declarations in the at least one policy. Finally, the policy provided with the signature and the identification data provided with the signature are transferred to the second computer. In this way, the administration of policies is entrusted to a third computer, the user of the mobile program preferably having a relationship of trust with this computer. The trust which the user has for the third computer amounts, in particular, to the fact that he trusts the third computer to make restrictions on access rights using the policies on a need-to-know basis, that is to say that the policies on the third computer are optimized for data integrity such that only data access operations which are absolutely necessary for the program operations are granted. The trust that a policy optimized in terms of security aspects will be used for the mobile program is thus moved to a third location in the form of a third computer. The user therefore needs to trust the first computer only to the extent that the program also has the desired functionality when executed using the policies on the third computer. In addition, the user of the program no longer has to create the policies himself, but rather the creation of the policies is entrusted to a third location.

In the case of the embodiment just described, the mobile program is preferably provided with a digital signature in the first computer, and the mobile program is assigned a URL (Uniform Resource Locator) address, the identification data comprising the certificate which belongs to the digital signature and the URL address. The use of a certificate instead of the digital signature is advantageous, since the certificate does not change even if the program changes, for example in the case of a new debugged program version. Since a program in a new version essentially has the same functionality, identification on the basis of the program's functionality is thus possible. This also makes sense, since a policy which has been created fits in primarily with the program functionality.

In another preferred embodiment of the invention, the policies are created by a third computer using the mobile program and a set of prescribed access rights and declarations. In this context, the prescribed access rights and declarations are preferably also stored on the third computer. Alternatively, the set of prescribed declarations may be stored on the third computer, whereas the set of prescribed access rights is stored on the first computer and can be retrieved by the third computer. In another alternative, the set of prescribed access rights may be stored on the third computer, whereas the set of prescribed declarations is stored on a further computer and can be retrieved by the third computer. It is thus of no significance which location provides the prescribed declarations or access rights, the only crucial factor being that the policies in question are created in the third computer from these data.

In another preferred embodiment, the mobile program is transferred using a connection (e.g. HMAC) which is protected from data manipulation, and computer 1 is identified using a suitable method. The relationship of trust is thus set up between the user of the program and a computer belonging to the manufacturer or a computer which the manufacturer entrusts with the distribution of his programs.

In another embodiment of the invention, policies which are specific to prescribed program applications and/or prescribed target user groups are created, the mobile program being able to be executed using the specific policies, and the specific policies being able to be selected by a user. A user can therefore take the program functionality or data integrity which he wants as a basis for selecting appropriate policies, with the assurance that the mobile program can also be executed using these policies. The selection of a policy can also be automated by taking a program application profile which is input by the user as a basis for ascertaining a policy which is suitable for the program application profile.

The inventive method has two conceivable implementation scenarios. In one scenario, at least one of the policies is loaded onto the second computer from the first computer together with the mobile program. In the other scenario, at least one of the policies is loaded onto the second computer from a third computer. The first scenario is used when the policies are provided by the first computer, and the second scenario is used when the policies are created and provided by a third location.

The mobile program transferred using the invention is preferably written in a programming language chosen from Java™, Save-TCL™, Calm™, Microsoft Authentic Code, Microsoft™ ActiveX. Any other program language which can be used to produce a mobile program is also conceivable, however.

In another embodiment of the invention, there is an arrangement for transferring mobile programs, where the arrangement can be used to carry out the inventive method. The arrangement comprises a first computer and a second computer, the mobile program being able to be executed on the second computer. The arrangement is configured such that the mobile program can be loaded onto the second computer from the first computer, with one or more policies being stored which stipulate a set of access rights for the mobile program regarding data which are to be processed by the mobile program, the policies being able to be loaded onto the second computer. In addition, the policies used comprise one or more declarations which can be displayed to the user of the program, the declarations containing information relating to execution of the program with the access rights stipulated by the policies.

### BRIEF DESCRIPTION OF THE DRAWINGS

Exemplary embodiments of the invention are illustrated and explained below with reference to the drawing, in which:

FIG. 1 shows an arrangement which can be used to carry out the invention.

### DETAILED DESCRIPTION OF THE INVENTION

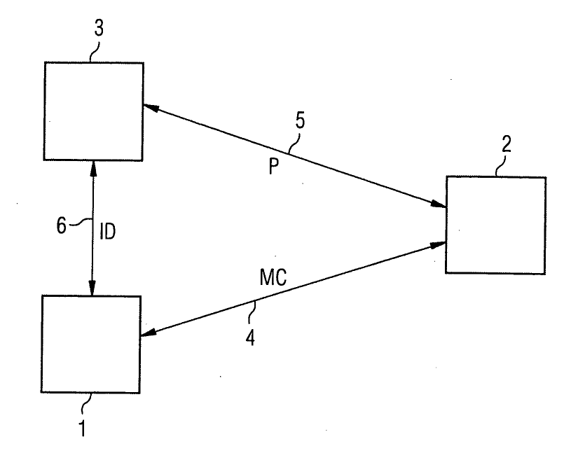

The arrangement for transferring mobile programs which is shown in FIG. 1 comprises a first computer 1, a second computer 2 and a third computer 3. On the first computer 1, the mobile program MC (Mobile Code) is made available, the program being transferred to the computer 2 via a data link 4. The computer 2 is a personal computer belonging to a user, the programs from computer 1 being able to be executed on the personal computer. The data link 4 is a secure data link which is protected against external data manipulation, for example using signed transfer of the data. The computer 1 and the computer 2 have a relationship of trust, the programs being signed in computer 1 and the signature being checked by computer 2.

Besides the program MC, security policies P are also made available in the third computer 3, the policies being able to be transferred to the computer 2. The computer 2 and the computer 3 also have a relationship of trust which can be ensured by a signature, for example. The policies are downloaded via the data link 5, which is preferably a secure data link, the security being ensured, by way of example, by cryptographical checksums using a secret key.

The policies stored in the computer 3 stipulate a set of access rights for corresponding mobile programs stored in the computer 1. Policies have been created individually for each mobile program, with particular attention being paid to which access rights are necessary for a corresponding mobile program. The computer 3 therefore provides policies optimized for corresponding mobile programs. Creation of the policies is thus transferred to a third computer and is not performed by the user of the computer 2 himself.

For creation of the policies, it has also been ensured that the user of the mobile program is also able to understand the content of the policies. For this reason, the policies include declarations intended for the user, the declarations including information relating to execution of the mobile program with the access rights stipulated by the policies. These declarations can be displayed to the user prior to execution of the program.

To transfer a mobile program from the computer 1 to the computer 2, the mobile program is downloaded onto the computer 2 via the data link 4. In addition, identification data ID for the program are transferred to the computer 3 via a data link 6. The data link 6 is preferably a secure data link. In the computer 2, the identification data for the mobile program are assigned to corresponding policies which can be used to execute the mobile program. The policies are then downloaded to the computer 2 via the data link 5 together with the identification data ID.

Finally, the computer 2 stores the mobile program MC and also corresponding policies P associated with the program. The user can then look at the declarations intended for him in the policies and can decide which policy he wishes to use to execute the mobile program. In the case of an Internet banking program, the declarations may be, by way of example: “You can this program to perform secure bank transactions”. The user then knows that the policy ensures secure data transfer for bank transactions, and he can then execute the program with the access rights stipulated by the policies. In addition, it is possible for the user to take the information from the declarations in the policies as a basis for selecting a policy which is suitable for him in accordance with his security requirements.

The invention thus allows the user to transfer the creation of policies to a trustworthy third location (in the present case the computer 3), with the content of the policies being shown transparently to the user. This provides the user of a mobile program with a tool giving him information about security-critical program operations.

1. A method for transferring mobile programs from a first computer to a second computer, on which the mobile program can be executed, comprising:
loading the mobile program onto the second computer from the first computer;
loading one or more policies onto the second computer, the policies stipulating a set of access rights for the mobile program regarding data which are to be processed by the mobile program; and
displaying the policies, which comprise one or more declarations, to the user of the mobile program, the declarations including information relating to execution of the mobile program with the access rights stipulated by the policies.

2. The method as claimed in claim 1, in which the declarations relate to security-critical program operations in the mobile program.

3. The method as claimed in claim 1, in which the policies include declarations for different target user groups.

4. The method as claimed in claim 1, further comprising:
transferring identification data for identifying the mobile program from the first computer to a third computer, the third computer having access to the policies;
providing at least one of the policies and the identification data with a signature, the signature being used to declare that a mobile program which can be identified using the identification data is behaving in accordance with the declarations in the at least one policy; and
transferring the policies provided with the signature and the identification data provided with the signature to the second computer.

5. The method as claimed in claim 4, in which the mobile program has an associated URL address and the mobile program in the first computer is made available after having been provided with a digital signature, the identification data comprising a certificate which belongs to the digital signature and the URL address.

6. The method as claimed in claim 1, in which the policies are created by a third computer using the mobile program and a set of prescribed access rights and declarations.

7. The method as claimed in claim 6, in which the set of prescribed access rights and declarations is stored on the third computer.

8. The method as claimed in claim 6, in which the set of prescribed declarations is stored on the third computer and the set of prescribed access rights is stored on the first computer, the set of prescribed access rights being able to be retrieved by the third computer.

9. The method as claimed in claim 6, in which the set of prescribed access rights is stored on the third computer and the set of prescribed declarations is stored on a further computer, the set of prescribed declarations configured to be retrieved by the third computer.

10. The method as claimed in claim 1, in which the mobile program is transferred using a connection which is protected against data manipulation, and the first computer is identified using an identification method.

11. The method as claimed in claim 1, wherein policies which are specific to prescribed program applications and/or prescribed target user groups are created, the mobile program configured to be executed using the specific policies, and the specific policies configured to be selected by a user.

12. The method as claimed in claim 11, wherein the specific policies comprise access rights which are specific to the target user groups.

13. The method as claimed in claim 11, wherein a program application profile which is input by the user is taken as a basis for ascertaining a policy which is suitable for the program application profile.

14. The method as claimed in claim 1, wherein at least one of the policies is loaded onto the second computer from the first computer together with the mobile program.

15. The method as claimed in claim 1, wherein at least one of the policies is loaded onto the second computer from a third computer.

16. The method as claimed in claim 1, wherein the mobile program is written in a programming language chosen from Java™, Safe-Tcl™, Caml™, Microsoft™ Authenticode, Microsoft™ ActiveX.

17. An arrangement for transferring mobile programs, comprising:
a first computer; and
a second computer, on which the mobile programs can be executed, wherein
the mobile program is configured to be loaded onto the second computer from the first computer;
one or more policies are stored which stipulate a set of access rights for the mobile programs regarding data which are to be processed by the mobile programs, the policies configured to be loaded onto the second computer;
the policies comprise one or more declarations which are displayed to the user of the mobile program, the declarations including information relating to execution of the mobile programs with the access rights stipulated by the policies.
